(19) United States
(12) Patent Application Publication
(10) Pub. No.: US 2017/0331714 A1
(43) Pub. Date: Nov. 16, 2017

(54) DYNAMIC CCA SCHEME WITH LEGACY DEVICE COEXISTANCE

(71) Applicant: INTEL CORPORATION, Santa Clara, CA (US)

(72) Inventors: Rongzhen YANG, Shanghai (CN); Yongsen MA, Williamsburg, VA (US); Qinghua LI, San Ramon, CA (US); Peng MENG, Shanghai (CN)

(21) Appl. No.: 15/525,212

(22) PCT Filed: Dec. 15, 2014
(86) PCT No.: PCT/CN2014/093808

§ 371 Date: May 8, 2017

(51) Int. Cl. H04L 12/26; H04W 16/14; H04W 24/10; H04W 74/08

(52) U.S. Cl. CPC H04L 43/0888; H04W 74/0808; H04W 16/14; H04W 24/10

(57) ABSTRACT

One key performance indicator of legacy devices is throughput. In a co-existence or mixed environment with HEW and legacy devices, this throughput of the legacy device(s) can be greatly degraded or reduced to nearly 0 when existing CCA adjustment techniques are utilized. By using a joint-sensing-adapting scheme to adjust CCA levels, this problem can be addressed.

### TECHNICAL FIELD

An exemplary aspect is directed toward communications systems. More specifically an exemplary aspect is directed toward wireless communications systems and even more specifically to CCA (Clear Channel Assessment) in wireless communications systems.

### BACKGROUND

Wireless networks are ubiquitous and are commonplace indoors and becoming more frequently installed outdoors. Wireless networks transmit and receive information utilizing varying techniques. For example, but not by way of limitation, two common and widely adopted techniques used for communication are those that adhere to the Institute for Electronic and Electrical Engineers (IEEE) 802.11 standards such as the 802.11n standard and the IEEE 802.11ac standard.

The 802.11 standard specifies a common Medium Access Control (MAC) Layer which provides a variety of functions that support the operation of 802.11-based wireless LANs (WLANs). The MAC Layer manages and maintains communications between 802.11 stations (such as between radio network cards (NIC) in a PC or other wireless devises or stations (STA) and access points (APs)) by coordinating access to a shared radio channel and utilizing protocols that enhance communications over a wireless medium.

802.11n was introduced in 2009 and improved the maximum single-channel data rate from 54 Mbps of 802.11g to over 100 Mbps. 802.11n also introduced MIMO (multiple input/multiple output or spatial streaming), where, according to the standard, up to 4 separate physical transmit and receive antennas carry independent data that is aggregated in a modulation/demodulation process in the transceiver. (Also known as SU-MIMO (single-user multiple input/multiple output.))

The IEEE 802.11ac specification operates in the 5 GHz band and adds channel bandwidths of 80 MHz and 160 MHz with both contiguous and non-contiguous 160 MHz channels for flexible channel assignment. 802.11ac also adds higher order modulation in the form of 256 quadrature amplitude modulation (QAM), providing a 33-percent improvement in throughput over 802.11n technologies. A further doubling of the data rate in 802.11ac is achieved by increasing the maximum number of spatial streams to eight.

IEEE 802.11ac further supports multiple concurrent downlink transmissions (“multi-user multiple-input, multiple-output” (MU-MIMO)), which allows transmission to multiple spatial streams to multiple clients simultaneously. By using smart antenna technology, MU-MIMO enables more efficient spectrum use, higher system capacity and reduced latency by supporting up to four simultaneous user transmissions. This is particularly useful for devices with a limited number of antennas or antenna space, such as smartphones, tablets, small wireless devices, and the like. 802.11ac streamlines the existing transmit beamforming mechanisms which significantly improves coverage, reliability and data rate performance.

IEEE 802.11ax is the successor to 802.11ac and is proposed to increase the efficiency of WLAN networks, especially in high density areas like public hotspots and other dense traffic areas. 802.11ax will also use orthogonal frequency-division multiple access (OFDMA). Related to 802.11ax, the High Efficiency WLAN Study Group (HEW SG) within the IEEE 802.11 working group is considering improvements to spectrum efficiency to enhance system throughput/area in high density scenarios of APs (Access Points) and/or STAs (Stations).

Carrier Sense (CS) is a fundamental part of wireless networks, and in particular Wi-Fi networks. Since Wi-Fi communicates information over a shared medium, random access to the medium is available to all stations within the network. As such, carrier sense and medium contention are fundamental to network operation and efficiency in order to avoid collisions and interference.

Wi-Fi carrier sense includes two steps—clear channel assessment (CCA) and network allocation vector (NAV). In general CCA is a physical carrier sense which measures received energy in the radio spectrum. NAV is a virtual carrier sense which is generally used by wireless stations to reserve certain portions of the medium for mandatory transmission that would occur after a first transmission. In general, CCA assessment is for determining whether the medium is busy for a current frame and NAV is utilized to determine whether the medium will be busy for future frames.

CCA is defined by IEEE 802.11-2007 and includes two interrelated functions—carrier sense (CS) and energy detection (ED). Carrier sense is functionality performed by the receiver to detect and decode an incoming Wi-Fi preamble signal. The CCA is indicated as busy when another Wi-Fi preamble signal is detected, and held in the busy state based on information in the length field of the preamble.

Energy detection (ED) occurs when a receiver detects a non-Wi-Fi energy level present on a channel (within a frequency range) based on a noise floor, ambient energy, interference sources, an unidentifiable Wi-Fi transmissions that, for example, cannot be decoded, or the like. ED samples the medium every time slot to determine whether energy is present and, based on a threshold, reports as to whether it is believed that the medium is busy.

In addition to the CCA identifying whether the medium is idle or busy for a current frame and noise, the NAV, as discussed, allows stations to indicate an amount of time required for transmission of mandatory frames following transmission of a current frame. NAV is a critical component of Wi-Fi to ensure the medium is reserved for frames that are essential to the operation of the 802.11 protocol. As discussed in the 802.11 standard, NAV is carried in the 802.11 MAC header duration field and encoded at a variable data rate. The station that receives the NAV header duration field can use this information to wait the specified period until the medium is free.

In accordance with one exemplary embodiment, a reduced interference dynamic CCA scheme that uses environment sensing is proposed which will work in any compatible wireless system or environment, including the 802.11 standards mentioned herein and in particular 802.11ac and 802.11ax. The environment sensing dynamic CCA scheme can, for example, greatly improve overall wireless LAN system performance compared to other methods.

In the current IEEE 802.11ax standard development, densification (densification at least includes densification over space, such as dense deployment of small cells, and frequency, such as utilizing larger portions of the radio spectrum in diverse bands) is one of the key technical topics targeted for enhancement in system efficiency for OBSS (Overlapping Basic Service Set) environments. In the current Task Group (IEEE 802.12ax), CCA level adjustment for spatial reuse is one of the top topics as a key promising field for performance and efficiency improvement.

However, in a recent Task Group study, one disadvantage of adjusting the CCA level for “new” HEW device (a HEW device presented within a wireless coverage area) was found: legacy device performance is greatly degraded where a mixed environment with legacy and HEW devices is present. The issue is common for all current CCA adjustment algorithms, and there is no known solution to address this issue.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary communications environment with HEW and Legacy devices;

FIG. 2 illustrates an exemplary communications device;

FIG. 3 is a flowchart illustrating an exemplary CCA technique using a joint sensing-adapting scheme; and

FIG. 4 is a flowchart illustrating an exemplary method for updating a CCA threshold.

### DESCRIPTION OF EMBODIMENTS

One exemplary embodiment is directed toward a technique to solve this issue, which can greatly reduce the performance degradation of the legacy devices in a co-existence environment (Legacy device(s) and HEW devices), and can be applied to all CCA methods to achieve improvement.

More specifically, one key performance indicator of legacy devices is throughput. In a co-existence or mixed environment with HEW and legacy devices, this throughput of the legacy device(s) can be greatly degraded to nearly 0 when existing CCA adjustment techniques are utilized. By using a joint-sensing-adapting scheme to adjust CCA levels, this problem can be addressed.

In the following detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

Before undertaking the description of embodiments below, it may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments will be described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links 5, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The above problem can be addressed by using environment sensing. The existing CSMA (Carrier Sense Multiple Access) of WiFi requires devices to capture packets over the air in a “listen mode.” Also, legacy packets can be identified from the physical layer header, i.e., the SIG field. Thus, using these techniques, a HEW device can easily count or otherwise identify a number of legacy and HEW devices within an environment. Furthermore, a HEW device can optionally also determine a received power level of one or more of the devices in the environment. Utilizing this information, a HEW device can determine and select an appropriate CCA level to assist with improving or maximizing HEW device performance while at the same time reducing or minimizing impact to one or more of the legacy devices in the environment.

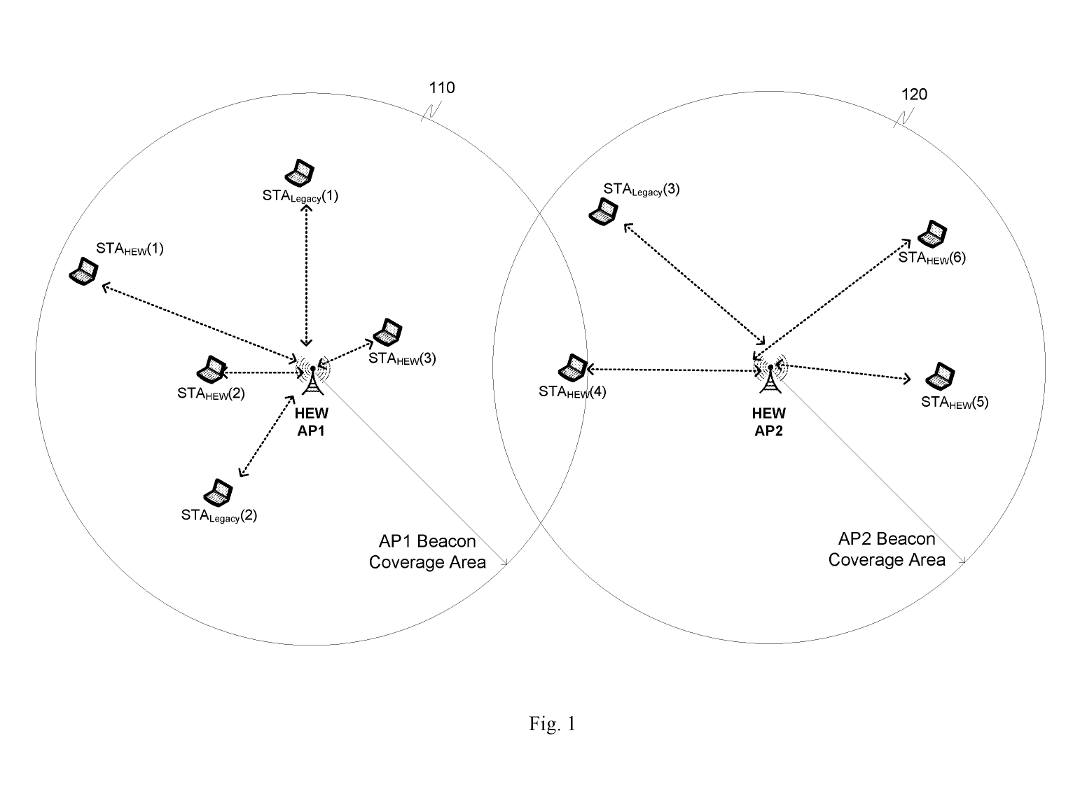

To illustrate the problem and the proposed solution, reference is made to FIG. 1. In FIG. 1, two beacon coverage areas are shown: AP1 (Access Point 1) Beacon Coverage Area 110 and AP2 Beacon Coverage Area 120. Within AP1 there are three HEW stations (STA_{HEW}(1)-STA_{HEW}(3)) and two legacy stations (STA_{Legacy}(1)-STA_{Legacy}(²)) and one HEW access point (HEW AP1). Within AP2 there are three HEW stations (STA_{HEW}(4) -STA_{HEW}(6)) and one legacy station (STA_{Legacy}(3)) and one HEW access point (HEW AP2). As is appreciated, there can be any number of HEW stations and/or legacy stations within each of the AP1 and AP2, and/or additional beacon coverage areas (not shown) with a combination of HEW and/or legacy stations therein.

To assist with understanding the environment illustrated in FIG. 1, this type of environment can be modeled as follows:

Device Naming:

N legacy devices named as Device_{Legacy}(i), i=1˜N, which include both AP and STA (Stations),

M HEW devices named as Device_{HEW}(j), j=1˜M, which include both AP and STA.

For CCA Naming:

For legacy devices, the CCA level is decided by its working mode (according to the corresponding standard version, such as IEEE 802.11b/a/g/n/ac), expressed as:

CCA_{Legacy}

For HEW devices, the CCA level is determined by one or more techniques such as those used for pure HEW deployment, expressed as: CCA_{HEW}, with the technique to decide this kind of CCA level having many candidate solutions—any of which working with the techniques discussed herein. See, for example, 11-14-0779-02-00ax-dsc-practical-usage.pptx, by Graham Smith, DSP Group, or 11-14-0082-00-0hew-improved-spatial-reuse-feasability-part-i.pptx, by Ron Porat, from Broadcom.

For the CCA level decided by the techniques disclosed herein, for mixed deployment, the CCA level is expressed as CCA_{optimized}.

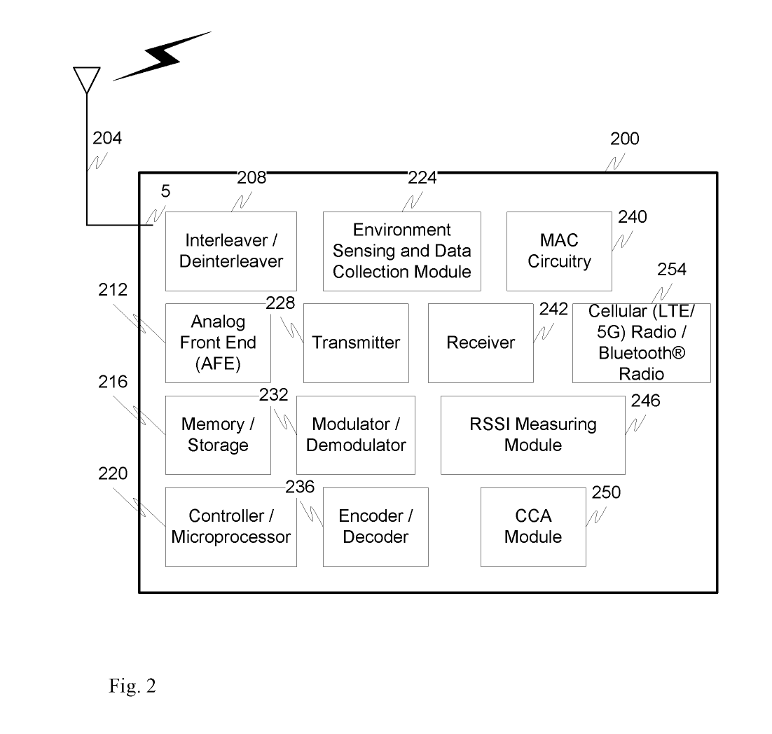

FIG. 2 illustrates an exemplary transceiver, such as that found in a station or an access point adapted, to implement the techniques herein. In addition to well-known componentry (which has been omitted for clarity), the transceiver 200 includes one or more antennas 204, an interleaver/deinterleaver 208, an analog front end 212, memory/storage 216, controller/microprocessor 220, environment sensing and data collection module 224, transmitter 228, modulator/demodulator 232, encoder/decoder 236, MAC Circuitry 240, receiver 242, an RSSI measuring module 246, a CCA module 250 and optionally one or more radios such as the cellular radio/Bluetooth®/Bluetooth® low energy radio 254. The various elements in the transceiver 200 are connected by one or more links 5 (not shown, again for sake of clarity).

The wireless device 200 can have one more antennas 204, for use in wireless communications such as multi-input multi-output (MIMO) communications, Bluetooth®, etc. The antennas 204 can include, but are not limited to directional antennas, omnidirectional antennas, monopoles, patch antennas, loop antennas, microstrip antennas, dipoles, and any other antenna(s) suitable for communication transmission/reception. In an exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users.

Antenna(s) 204 generally interact with an Analog Front End (AFE) 212, which is needed to enable the correct processing of the received modulated signal. The AFE 212 can sit between the antenna and a digital baseband system in order to convert the analog signal into a digital signal for processing.

The wireless device 200 can also include a controller/microprocessor 220 and a memory/storage 216. The wireless device 200 can interact with the memory/storage 216 which may store information and operations necessary for configuring and transmitting or receiving the information described herein. The memory/storage 216 may also be used in connection with the execution of application programming or instructions by the controller/microprocessor 220, and for temporary or long term storage of program instructions and/or data. As examples, the memory/storage 220 may comprise a computer-readable device, RAM, ROM, DRAM, SDRAM and/or other storage devices and media.

The controller/microprocessor 220 may comprise a general purpose programmable processor or controller for executing application programming or instructions related to the wireless device 200. Further, controller/microprocessor 220 can perform operations for configuring and transmitting information as described herein. The controller/microprocessor 220 may include multiple processor cores, and/or implement multiple virtual processors. Optionally, the controller/microprocessor 220 may include multiple physical processors. By way of example, the controller/microprocessor 220 may comprise a specially configured Application Specific Integrated Circuit (ASIC) or other integrated circuit, a digital signal processor, a controller, a hardwired electronic or logic circuit, a programmable logic device or gate array, a special purpose computer, or the like.

The wireless device 200 can further include a transmitter 228 and receiver 242 which can transmit and receive signals, respectively, to and from other wireless devices or access points using one or more antennas. Included in the wireless device 200 circuitry is the medium access control or MAC Circuitry 240. MAC circuitry 240 provides the medium for controlling access to the wireless medium. In an exemplary embodiment, the MAC circuitry 240 may be arranged to contend for a wireless medium and configure frames or packets for communicating over the wireless medium.

The wireless device 104 can also optionally contain a security module (not shown). This security module can contain information regarding but not limited to, security parameters required to connect the wireless device 1 to an access point or other device or other available network(s), and can include WEP or WPA security access keys, network keys, etc. The WEP security access key is a security password used by Wi-Fi networks. Knowledge of this code will enable the wireless device to exchange information with the access point. The information exchange can occur through encoded messages with the WEP access code often being chosen by the network administrator. WPA is an added security standard that is also used in conjunction with network connectivity with stronger encryption than WEP.

In addition to well-known operational steps which will not be described, in operation, and a communication session, such as a Wi-Fi communication session, has started, and in cooperation with the environment sensing and data collection module 224, environmental sensing commences. More specifically, the device 200, in cooperation with the environmental sensing and data collection module 224, processor 220 and storage 216, will begin sensing the environment for a period of time T_{Sensing} to collect data as follows:

1) Received RSSI from all active devices during the sensing period T_{Sensing}:

Legacy Device: RSSI_{Legacy}(i), i=1˜N

HEW Device: RSSI_{HEW}(j), j=1˜M

where, the RSSI value is expressed as a linear value which is then used for the next processing step.

2) The environment sensing and data collection module 224 will log all active devices air transmission time during the sensing period T_{Sensing}:

Legacy Device: T_{Legacy}(i), i=1˜N

HEW Device: T_{HEW}(j), j=1˜M

After the sensing period T_{Sensing}, the technique progresses to determine and set the CCA value.

More specifically, and in cooperation with the CCA module 250, the device 200 uses the information collected by the environment sensing and data collection module 224 to update the CCA level. The updating of the CCA level is a two-step process, with the first step determining a CCA weight ratio, and the second step updating the CCA level by using the weight ratio determination.

For the CCA weight ratio r calculation, two alternatives can be used to determine this value with the first of the alternatives determining the CCA weight ratio by only using RSSI measurement value information from the RSSI measuring module 246. The second alternative determines the CCA weight ratio by using both RSSI measurement value information and signal air time.

More specifically, for the first alternative, the CCA weight ratio is determined using only RSSI measurement value information that is calculated in accordance with:

$$r = \frac{{\sum }_{j = 1}^{M} {RSSI}_{HEW} ( j )}{{\sum }_{i = 1}^{N} {RSSI}_{Legacy} ( i ) + {\sum }_{j = 1}^{M} {RSSI}_{HEW} ( j )}$$

For the second alternative, the CCA weight ratio is determined by using both RSSI measurement value information and signal air time in accordance with:

$$r = \frac{{\sum }_{j = 1}^{M} {T}_{HEW} ( j ) \times {RSSI}_{HEW} ( j )}{{\sum }_{i = 1}^{N} {T}_{Legacy} ( i ) \times {RSSI}_{Legacy} ( i ) + {\sum }_{j = 1}^{M} {T}_{HEW} ( j ) \times {RSSI}_{HEW} ( j )}$$

Next, and regardless of which CCA weight ratio determination is used, the CCA module 250 updates the CCA level by using the weight ratio calculation in accordance with:

CCA_{optimized}=CCA_{Legacy}r×(CCA_{HEW}−CCA_{Legacy})

Then, and in cooperation with the CCA module 250 and memory 216, and before the CCA value is updated, CCA_{optimized} is stored and used by the conventional CCA based channel accessing scheme (included in the value of CCA_{Legacy}) as defined in sections 18.3.6, 18.3.10.6, and 18.3.12 of the current IEEE 802.11-12 IEEE LAN, Part 11.

To assist with the implementation of the techniques disclosed herein, some optional supplemental techniques can be added to the operation of the device 200 to assist with implementation. First, and at the stations (STA), it may be useful to define measurement requirements on the station side, to ensure the same behavior of each device. For example, the detection of which Wi-Fi version could be standardized. The HEW device can be asked to differentiate between the legacy and HEW neighbors from their packets. Second, the measurement of the signal strength of received Wi-Fi messages, i.e., RSSI, could be standardized. The standard may define the measurement accuracy requirement and error range. Third, the transmission time of each detected message from neighboring devices, including both legacy and HEW devices, could be included in the decision statistics. The standard could also define the measurement accuracy requirement and error range.

On the access point (AP) side, and to assist with algorithm execution, the following modifications to device operation may also be useful. Specifically, the following parameters' information may be included in the broadcast message of the HEW access point:

1) The value sensing period T_{Sensing}, could may be expressed as 8 bits with unit of seconds,

2) The CCA weight ratio determination—Alternative algorithm selection: if there are only two alternatives as discussed herein, one bit of information could be included for the HEW device to decide which of the alternatives is to be used, and

3) CCA_{HEW}: in the instance of the CCA level of all devices inside one BSS being the same, and decided by the access point, this value could be expresses such as 8 bits or 12 bits or 16 bits for the value in dBm broadcast by the access point.

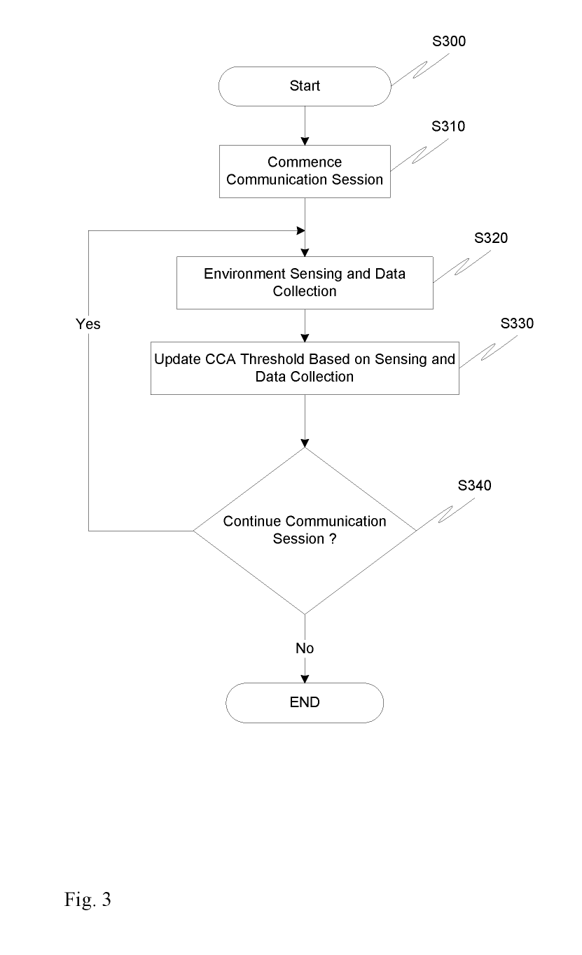

FIG. 3 outlines an exemplary technique for the dynamic CCA scheme as discussed herein. In particular control begins in step S300 and continues to step S310. In step S310, the communication session commences. Next, in step S320, environment sensing and data collection commences. Then, in step S330, the CCA threshold is updated based on the sensed environment and data collection process. Control then continues to step S340.

In step S340, a determination is made as to whether the communications session should continue. If the communication session should continue, control jumps back to step S320 with control otherwise continuing to step S350 where the control sequence ends.

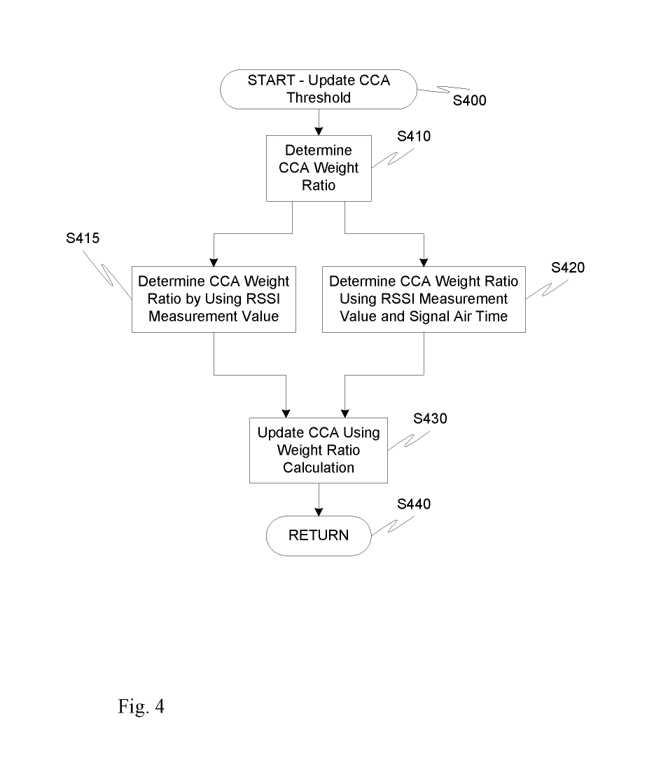

FIG. 4 outlines in greater detail the updating of the CCA threshold step S330. In particular, control begins in step S400 and continues to step S410. In step S410, and as outlined above, the CCA weight ratio is determined. More specifically, one of two alternatives as illustrated in steps S415 and S420 are used to determine the CCA weight ratio. In the first alternative in step S415, the CCA weight ratio is determined by using an RSSI measurement value. Otherwise, in step S420, CCA weight ratio is determined using an RSSI measurement value and signal error time. Having determined the CCA weight ratio, control continues to step S430 where the CCA is updated using one of the two alternative weight ratio calculations. Control then continues to step S440 where the control sequence ends.

The exemplary embodiments are described in relation to CCA determination in a wireless transceiver. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to 802.11 transceivers and associated communication hardware, software and communication channels. However, to avoid unnecessarily obscuring the present disclosure, the following description omits well-known structures and devices that may be shown in block diagram form or otherwise summarized.

Exemplary aspects are directed toward:
A communications device comprising:
   a processor; and
   an environment sensing and data collection module adapted to receive RSSI (Received Signal Strength Indication) information and air transmission time for one or more devices in a beacon coverage area; and
   a CCA (Clear Channel Assessment) module adapted to update a CCA of the device based on the RSSI information and air transmission time.
Any one or more of the above aspects, further comprising an RSSI module adapted to measure RSSI information from all active devices within the beacon coverage area.
Any one or more of the above aspects, wherein all active devices include one or more of legacy devices and HEW devices.
Any one or more of the above aspects, wherein the CCA is updated based on a CCA weight ratio.
Any one or more of the above aspects, wherein the CCA weight ratio is based on an RSSI measurement value.
Any one or more of the above aspects, wherein the CCA weight ratio is based on an RSSI measurement value and a signal air time.
Any one or more of the above aspects, wherein the device is a WiFi communications device.
Any one or more of the above aspects, further comprising a transmitter, a receiver, at least one antenna, a controller and MAC circuitry.
Any one or more of the above aspects, wherein the device determines received power levels of the one or more devices in the beacon coverage area and counts a number of legacy devices and HEW devices in the beacon coverage area.
Any one or more of the above aspects, wherein the device is a HEW station or access point.
A dynamic CCA method comprising:
   receiving RSSI (Received Signal Strength Indication) information and air transmission time for one or more devices in a beacon coverage area; and
   updating a CCA (Clear Channel Assessment) of the device based on the RSSI information and air transmission time.
Any one or more of the above aspects, further comprising measuring RSSI information from all active devices within the beacon coverage area.
Any one or more of the above aspects, wherein all active devices include one or more of legacy devices and HEW devices.
Any one or more of the above aspects, wherein the CCA is updated based on a CCA weight ratio.
Any one or more of the above aspects, wherein the CCA weight ratio is based on an RSSI measurement value.
Any one or more of the above aspects, wherein the CCA weight ratio is based on an RSSI measurement value and a signal air time.
Any one or more of the above aspects, wherein the device is a WiFi communications device.
Any one or more of the above aspects, wherein the method is implemented on a transceiver comprising a transmitter, a receiver, at least one antenna, a controller and MAC circuitry.
Any one or more of the above aspects, further comprising determining received power levels of the one or more devices in the beacon coverage area and counting a number of legacy devices and HEW devices in the beacon coverage area.
Any one or more of the above aspects, wherein the device is a HEW station or access point.
A system comprising:
   means for receiving RSSI (Received Signal Strength Indication) information and air transmission time for one or more devices in a beacon coverage area; and
   means for updating a CCA (Clear Channel Assessment) of the device based on the RSSI information and air transmission time.
Any one or more of the above aspects, further comprising measuring RSSI information from all active devices within the beacon coverage area.
Any one or more of the above aspects, wherein all active devices include one or more of legacy devices and HEW devices.
Any one or more of the above aspects, wherein the CCA is updated based on a CCA weight ratio.
Any one or more of the above aspects, wherein the CCA weight ratio is based on an RSSI measurement value.
A non-transitory computer readable information storage media having stored thereon instructions, that when executed by one or more processors, cause to be performed a dynamic CCA method comprising:
   instructions for receiving RSSI (Received Signal Strength Indication) information and air transmission time for one or more devices in a beacon coverage area; and
   instructions for updating a CCA (Clear Channel Assessment) of the device based on the RSSI information and air transmission time.
Any one or more of the above aspects, further comprising instructions for measuring RSSI information from all active devices within the beacon coverage area.
Any one or more of the above aspects, wherein all active devices include one or more of legacy devices and HEW devices.
Any one or more of the above aspects, wherein the CCA is updated based on a CCA weight ratio.
Any one or more of the above aspects, wherein the CCA weight ratio is based on an RSSI measurement value.
Any one or more of the above aspects, wherein the CCA weight ratio is based on an RSSI measurement value and a signal air time.
Any one or more of the above aspects, wherein the device is a WiFi communications device.
Any one or more of the above aspects, wherein the method is implemented on a transceiver comprising a transmitter, a receiver, at least one antenna, a controller and MAC circuitry.
Any one or more of the above aspects, further comprising determining received power levels of the one or more devices in the beacon coverage area and counting a number of legacy devices and HEW devices in the beacon coverage area.
Any one or more of the above aspects, wherein the device is a HEW station or access point.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s) 5, connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an 802.11 transceiver, or the like. Examples of wireless protocols that can be used with this technology include 802.11a, 802.11b, 802.11g, 802.11n, 802.11ac, 802.11ad, 802.11af, 802.11ah, 802.11ai, 802.11aj, 802.11aq, 802.11ax, WiFi, LTE, 4G, Bluetooth®, WirelessHD, WiGig, WiGi, 3GPP, Wireless LAN, WiMAX, and the like.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented on one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can be used to implement the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIV1926EJS™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium, executed on programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has been provided systems and methods for dynamic CCA determination. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A communications device comprising:
a processor; and
an environment sensing and data collection module adapted to receive RSSI (Received Signal Strength Indication) information and air transmission time for one or more devices in a beacon coverage area; and
a CCA (Clear Channel Assessment) module adapted to update a CCA of the device based on the RSSI information and air transmission time.

2. The device of claim 1, further comprising an RSSI module adapted to measure RSSI information from all active devices within the beacon coverage area.

3. The device of claim 1, wherein all active devices include one or more of legacy devices and HEW devices.

4. The device of claim 1, wherein the CCA is updated based on a CCA weight ratio.

5. The device of claim 4, wherein the CCA weight ratio is based on an RSSI measurement value.

6. The device of claim 4, wherein the CCA weight ratio is based on an RSSI measurement value and a signal air time.

7. The device of claim 1, wherein the device is a WiFi communications device.

8. The device of claim 1, further comprising a transmitter, a receiver, at least one antenna, a controller and MAC circuitry.

9. The device of claim 1, wherein the device determines received power levels of the one or more devices in the beacon coverage area and counts a number of legacy devices and HEW devices in the beacon coverage area.

10. The device of claim 1, wherein the device is a HEW station or access point.

11. A method comprising:
receiving RSSI (Received Signal Strength Indication) information and air transmission time for one or more devices in a beacon coverage area; and
updating a CCA (Clear Channel Assessment) of the device based on the RSSI information and air transmission time.

12. The method of claim 11, further comprising measuring RSSI information from all active devices within the beacon coverage area.

13. The method of claim 11, wherein all active devices include one or more of legacy devices and HEW devices.

14. The method of claim 11, wherein the CCA is updated based on a CCA weight ratio.

15. The method of claim 14, wherein the CCA weight ratio is based on an RSSI measurement value.

16. The method of claim 14, wherein the CCA weight ratio is based on an RSSI measurement value and a signal air time.

17. The method of claim 11, wherein the device is a WiFi communications device.

18. The method of claim 11, wherein the method is implemented on a transceiver comprising a transmitter, a receiver, at least one antenna, a controller and MAC circuitry.

19. The method of claim 11, further comprising determining received power levels of the one or more devices in the beacon coverage area and counting a number of legacy devices and HEW devices in the beacon coverage area.

20. The method of claim 11, wherein the device is a HEW station or access point.

21-25. (canceled)
